(19) United States
(12) Patent Application Publication
(10) Pub. No.: US 2011/0267498 A1
(43) Pub. Date: Nov. 3, 2011

(54) IMAGE PICKUP APPARATUS AND CONTROL METHOD THEREFOR

(75) Inventor: Hiroshi Kaibara, Yokohama-shi (JP)

(73) Assignee: CANON KABUSHIKI KAISHA, Tokyo (JP)

(21) Appl. No.: 13/089,679

(22) Filed: Apr. 19, 2011

(30) Foreign Application Priority Data
Apr. 28, 2010 (JP) 2010-103191

(51) Int. Cl. H04N 5/335

(52) U.S. Cl. 348/231.99; 348/E05.031

(57) ABSTRACT

A low-priced image pickup apparatus that does not require a memory dedicated to store light-shielded image data for detection of defective pixels of an image pickup device. A system controller of the image pickup apparatus performs control such that two storage areas of a memory are used to store normal image data at the time of continuous shooting. At the time of shooting that requires noise reduction processing to subtract light-shielded image data from normal image data, the system controller performs control such that one of the storage areas is used to store the normal image data and the other storage area is used to store the light-shielded image data.

### BACKGROUND OF THE INVENTION

1. Field of the Invention

The present invention relates to an image pickup apparatus having an image pickup device, and a control method therefor.

2. Description of the Related Art

In recent years, various methods for detecting and correcting defective pixels of an image pickup device of an image pickup apparatus that captures an object image have been proposed. For example, Japanese Laid-open Patent Publication No. 2006-157192 discloses a method in which a normal image and a light-shielded image are acquired from an image pickup device in sequence, defective pixels in the light-shielded image are identified, and pixels of the normal image corresponding to the defective pixels are corrected. Japanese Laid-open Patent Publication No. 2006-5912 discloses a method in which a normal image and a light-shielded image are acquired from an image pickup device, pixels in the light-shielded image each having a pixel value exceeding a threshold value are determined as defective pixels, the light-shielded image is subtracted from the normal image to acquire a noise-removed signal, and the noise-removed signal is corrected based on the defective pixels.

However, with the techniques disclosed in Japanese Laid-open Patent Publications Nos. 2006-157192 and 2006-5912, the image pickup apparatus must be provided with a memory dedicated to store the light-shielded image for the detection of defective pixels. The provision of the dedicated memory causes a fear that the size of the image pickup apparatus would increase as well as the increase of the number of parts and price of the image pickup apparatus.

### SUMMARY OF THE INVENTION

The present invention provides an image pickup apparatus that does not require a memory dedicated to store light-shielded image data for the detection of defective pixels of an image pickup device and that is low in price, and provides a control method for the image pickup apparatus.

According to a first aspect of this invention, there is provided an image pickup apparatus, which comprises an image pickup device configured to photoelectrically convert an optical image into an image signal and output the image signal, an A/D conversion unit configured to convert the image signal output from the image pickup device into digital image data, a storage unit having at least first and second storage areas and configured to store the digital image data, and a control unit configured to perform control to store first image data photographed in a state where the image pickup device is not light-shielded into both the first and second storage areas when first shooting is performed, the control unit being configured to perform control to store the first image data into one of the first and second storage areas and store second image data photographed in a state where the image pickup device is light-shielded into another of the first and second storage areas when second shooting is performed.

According to a second aspect of this invention, there is provided a control method for the image pickup apparatus described in the first aspect.

With this invention, at least two storage areas for normal image data are ensured in the storage unit to thereby make the continuous shooting speed higher at the time of normal continuous shooting, and one of the storage areas is made available for storage of light-shielded image data at the time of shooting that requires noise reduction processing. It is therefore possible to provide a low-priced image pickup apparatus that does not require a memory dedicated to store the light-shielded image data for the detection of defects.

Further features of the present invention will become apparent from the following description of an exemplary embodiment with reference to the attached drawings.

### BRIEF DESCRIPTION OF THE DRAWINGS

FIG. 1 is a block diagram showing the construction of an image pickup apparatus according to one embodiment of this invention;

FIG. 2 is a flowchart showing part of a continuous still-image shooting process performed by the image pickup apparatus;

FIG. 3 is a flowchart showing the remaining part of the continuous still-image shooting process that follows the flowchart shown in FIG. 2;

FIG. 4 is a view showing states of the image pickup apparatus and its memory in time series in the case of normal continuous shooting; and

FIG. 5 is a view showing states of the image pickup apparatus and the memory in time series in the case of continuous shooting with noise reduction.

### DESCRIPTION OF THE EMBODIMENTS

The present invention will now be described in detail below with reference to the drawings showing a preferred embodiment thereof.

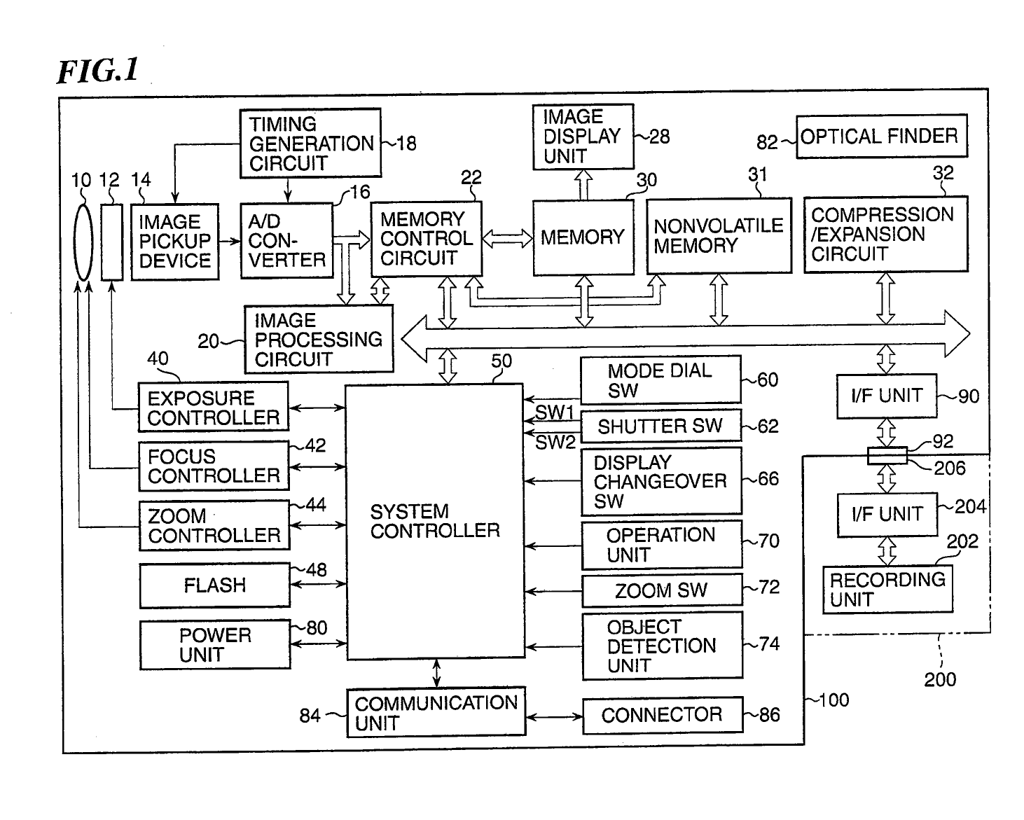

FIG. 1 shows in block diagram the construction of an image pickup apparatus according to one embodiment of this invention.

In FIG. 1, reference numeral 100 denotes the image pickup apparatus on which a recording medium 200 is removably mounted. In the following, a description of parts of the image pickup apparatus 100 not directly relating to the gist of this invention will be simplified or omitted.

With the image pickup apparatus 100, an optical image of an object is formed on an image pickup device 14 (image sensor) through a taking lens 10 and a mechanical shutter 12 having a diaphragm function. The optical image formed on the image pickup device 14 is photoelectrically converted into an electrical signal (image signal) by the image pickup device 14. An electric charge accumulation time in the image pickup device 14 can be controlled by controlling a reset timing of the device 14. The electrical signal output from the image pickup device 14 is converted into a digital signal by an A/D converter 16. A timing generation circuit 18 supplies a clock signal and a control signal to the image pickup device 14 and the A/D converter 16.

Data supplied from the A/D converter 16 or from a memory control circuit 22 is subjected to pixel interpolation and color conversion processing by an image processing circuit 20 that extracts an image from the data and performs zooming processing on the extracted image, whereby an electronic zoom function is achieved. The image processing circuit 20 performs calculation on image data, and based on a result of the calculation, performs TTL AF (auto-focus) processing, AE (automatic exposure) processing, EF (electric flash) processing, and AWB (automatic white balance) processing. At that time, a system controller 50 controls an exposure controller 40 and a focus controller (distance measurement controller) 42.

The data output from the A/D converter 16 is written into a memory 30 through the image processing circuit 20 and the memory control circuit 22 or through the memory control circuit 22. The written data is displayed on the image display unit 28 under the control of the memory control circuit 22, whereby an electronic view finder function is achieved.

The memory 30 has image data storage areas having a storage capacity which is large enough to store a predetermined number of still images (obtained by continuous shooting in which plural images are continuously photographed or obtained by panorama shooting) or store a moving image for a predetermined time. Further, the memory 30 has a work area for the system controller 50 and a JPEG buffer area for storing JPEG-compressed image data. A compression/expansion circuit 32 reads image data stored in the memory 30, performs compression/decompression processing (e.g., adaptive discrete cosine transformation (ADCT)) on the image data, and again writes the processed data into the memory 30.

The image data storage areas of the memory 30 include areas in which plural pieces (e.g., two pieces) of still image data are stored (hereinafter, referred to as the first and second storage areas Crw1, Crw2) and an area in which address data of defective pixels (defect address data) of the image pickup device 14 is developed (hereinafter, referred to as the defect address storage area). It is assumed that defect address data about defective pixels (defects) of the image pickup device 14 found by inspection at the factory before shipment is stored in advance in a nonvolatile memory 31. At the time of shooting, the stored defect address data is developed on the defect address storage area of the memory 30.

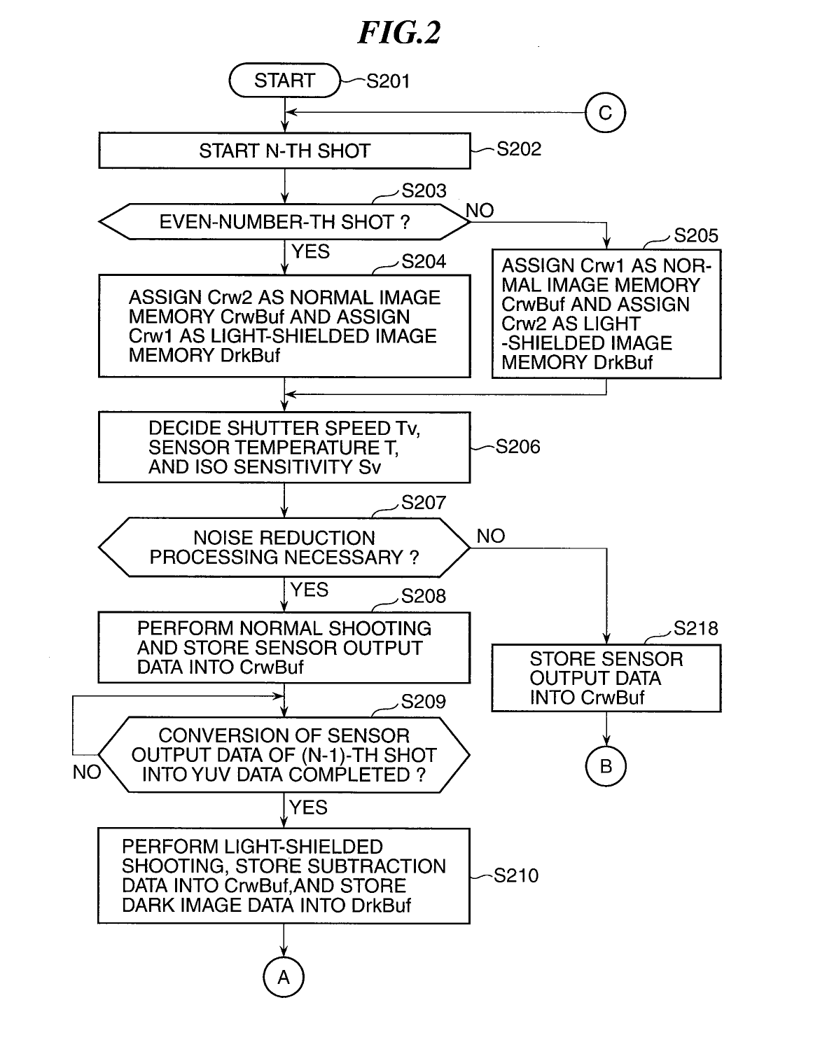

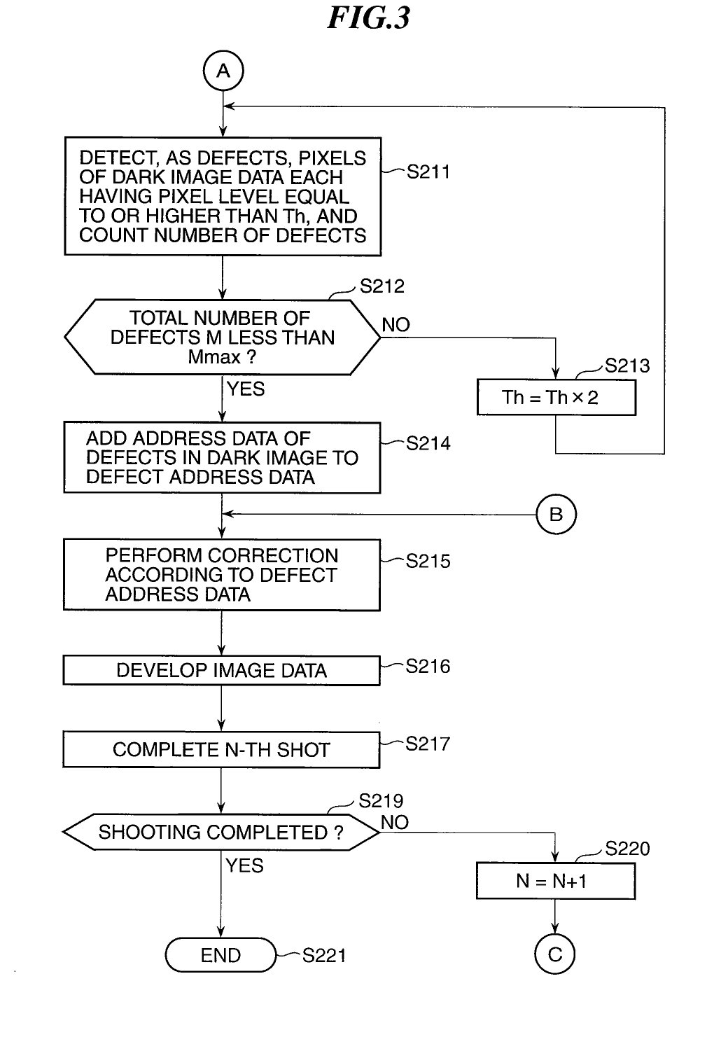

The nonvolatile memory 31 is implemented by, e.g., a flash ROM, and includes an area for storing program codes executed by the system controller 50 and an area for storing the defect address data. The system controller 50 for controlling the entire image pickup apparatus sequentially reads program codes from the nonvolatile memory 31 and executes a process shown in FIGS. 2 and 3 based on the read program codes.

The nonvolatile memory 31 further includes an area for storing system information and an area for storing user's setting information. It is therefore possible to restore a preceding operation state of the image pickup apparatus by reading various information from the nonvolatile memory 31 at the next startup of the apparatus.

The exposure controller 40 controls the shutter 12 and cooperates with a flash 48 to achieve a flash adjustment function. The focus controller 42 controls a focusing function of the taking lens 10. A zoom controller 44 controls a zooming function of the taking lens 10. The flash 48 has an AF auxiliary light projection function and a flash adjustment function. The system controller 50 controls the exposure controller 40 and the focus controller 42 based on results of light measurement and distance measurement.

A mode dial switch 60 is used to change settings of function modes such as a still image shooting mode, moving image shooting mode, continuous shooting mode, and panorama shooting mode. A shutter switch (shutter button) 62 is operated by a user to give an instruction about image pickup. When the shutter switch 62 is half-pressed, a switch SW1 is turned on to give an instruction to start the AF processing, AE processing, AWB processing, etc. When the shutter switch 62 is fully pressed, a switch SW2 is turned on to give an instruction to start a series of processing (image pickup processing, writing processing, developing processing, and recording processing), which are described below.

In the image pickup processing, an object image is captured, while controlling the shutter 12, image pickup device 14, flash 48, etc. In the writing processing, a signal read from the image pickup device 14 by the image pickup processing is converted into digital image data by the A/D converter 16. Then, the digital image data is written into the memory 30 through the memory control circuit 22.

In the developing processing, the image data (raw data) written in the memory 30 is developed by calculations by the image processing circuit 20 and memory control circuit 22. In the recording processing, the developed image data is compressed by the compression/expansion circuit 32 and written into the recording medium 200.

In the case of flash-shooting, after the EF processing is completed, the image pickup device 14 is exposed for an exposure time period decided in the AF processing. The flash 48 is caused to emit light during the exposure time period, and the exposure controller 40 completes exposure of the image pickup device 14 upon lapse of the exposure time period.

A display changeover switch 66 is used to change display on the image display unit 28. An operation unit 70 includes a menu button, single/continuous/self-timer changeover button, exposure correction button, etc., the details of which are omitted. A zoom switch 72 includes a tele switch for shifting the angle of view to a telephoto side and a wide switch for shifting the angle of view to a wide-angle side, and is used to give an instruction to change the zooming magnification. An object detection unit 74 detects an object to be photographed.

A power unit 80 is implemented by a primary battery, secondary battery, AC adapter, or the like. An optical finder 82 is used when shooting is performed without using the electronic finder function of the image display unit 28. A communication unit 84 has communication functions such as USB, IEEE 1394, LAN, and wireless communication. A connector 86 is connected to a connector (not shown) of an external device. For wireless communication, an antenna is provided. An interface (I/F) unit 90 provides an interface with the recording medium 200. A connector 92 is connected to a connector 206 of the recording medium 200.

The recording medium 200 is implemented by, e.g., a memory card or a hard disk, includes a recording unit 202 implemented by a semiconductor memory or a magnetic disk, and includes an interface (I/F) unit 204 and connector 206.

Next, a description will be given of operation of the image pickup apparatus 100 with reference to FIGS. 2 to 5.

FIGS. 2 and 3 show in flowchart a continuous still-image shooting process performed by the system controller 50.

Referring to FIG. 2, a continuous still-image shooting process is started when the mode dial switch 60 is set to the still-image shooting mode after the image pickup apparatus is started up by an operator by turning on a power switch, not shown (step S201). Next, a current shot (N-th shot) is started (step S202), and whether the current shot is an even-number-th (second, fourth, and so on) shot or a odd-number-th (first, third, and so on) shot is determined (step S203).

If it is determined that the current shot is an even-number-th shot, the storage area Crw2 of the memory 30 is assigned as a normal image memory CrwBuf for storing normal image data (first image data) obtained by performing shooting in a state where the image pickup device 14 is not light-shielded, and the storage area Crw1 of the memory 30 is assigned as a memory DrkBuf for storing light-shielded image data (second image data) obtained by performing shooting in state where the image pickup device 14 is light-shielded (step S204).

If it is determined in step S203 that the current shot is an odd-number-th shot, the storage area Crw1 of the memory 30 is assigned as the normal image memory CrwBuf, and the storage area Crw2 of the memory 30 is assigned as the memory DrkBuf for light-shielded image (step S205).

When it is determined that the switch SW1 of the shutter switch 62 is turned on, a shutter speed Tv and an ISO sensitivity Sv are decided and a temperature T of the image pickup device 14 (hereinafter, referred to as the sensor temperature T) is detected (step S206).

Based on the decided shutter speed Tv, the decided ISO sensitivity Sv, and the detected sensor temperature T, it is determined whether it is necessary to perform noise reduction processing on the image captured by the current shot to cancel noise applied to the captured image (step S207).

If it is determined that the noise reduction processing is required, normal shooting is first performed and sensor output data (normal image data) output from the image pickup device 14 is stored into the normal image memory (step S208). In the case of, e.g., the first shot, normal image data is stored into the storage area Crw1 of the memory 30 assigned as the normal image memory. After the normal image data is stored, light-shielded image shooting is performed. At that time, the system controller 50 performs the following processing.

Specifically, it is determined whether sensor output data of the preceding shot (i.e., (N−1)-th shot) has been converted into YUV data (Y denotes brightness data, and U and V denote color data) so that a free space becomes available in the memory for light-shielded image (step S209). In the case of, e.g., the first shot, waiting is made until a free space is available in the storage area Crw2 of the memory 30 assigned as the memory for light-shielded image. When a free space becomes available in the storage area of the memory for light-shielded image, light-shielded image shooting is performed and light-shielded image data is stored into the memory DrkBuf for light-shielded image. Then, normal image data is read from the normal image memory CrwBuf, and noise reduction processing is performed by subtracting the light-shielded image data from the read normal image data. The subtraction data after the noise reduction processing (third image data) is written back into the normal image memory CrwBuf (step S210).

Referring to FIG. 3, among pixels of light-shielded image data (dark image data) stored in the memory DrkBuf for light-shielded image, pixels each having a pixel level equal to or higher than a predetermined threshold value Th are detected as defects, and the number of the defects is counted (step S211).

Next, a storage capacity is calculated that is required for storing address data of the defects detected in step S211 from the light-shielded image and address data of defects detected by the inspection at the factory before shipment. Then, it is determined whether the calculated storage capacity is less than a maximum storage capacity of the defect address storage area of the memory 30. In this example, it is determined whether a sum M of the number of defects detected in step S211 and the number of defects detected by the inspection at the factory before shipment is less than a maximum value Mmax representing a maximum number of pieces of defect address data that can be stored in the defect address storage area (step S212).

If it is determined that the total number M of pieces of defect address data is equal to or greater than the maximum value Mmax, the threshold value Th used in step S211 for the detection of defects is doubled to a value of Th×2 (step S213), whereupon the flow returns to step S211. On the other hand, if it is determined that the total number M of pieces of defect address data is less than the maximum value Mmax, pieces of address data of defects detected in step S211 from the light-shielded image are stored into the defect address storage area of the memory 30 while being added to pieces of address data of defects detected by the inspection at the factory before shipment (step S214).

Next, defect correction is performed to correct pixels (indicated by the defect address data) in the image data that is stored in the normal image memory after being subjected to the noise reduction processing (step S215).

Next, the raw image data on which the defect correction has been made is developed by converting the raw image data into YUV data and by JPEG-compressing the YUV data, and the developed image data is stored into the JPEG buffer area of the memory 30 (step S216). Next, the image data in the JPEG buffer area is saved into the recording medium 200, whereby the N-th shot is completed (step S217).

If it is determined in step S207 that it is unnecessary to perform noise reduction processing for the current shot, the flow proceeds from step S207 to step S218 where sensor output data (normal image data) output from the image pickup device 14 is stored as is into the normal image memory CrwBuf. For example, in the case of the first shot, the normal image data is stored into the storage area Crw1 of the memory 30 assigned as the normal image memory. Next, the flow proceeds from step S218 to step S215, and the processing in steps S215 to S217 is performed.

Next, it is determined whether shooting is completed (step S219). If the answer to step S219 is NO, the number of times of shooting, N, is incremented to N+1 (step S220), whereupon the flow returns to step S202. On the other hand, if the answer to step S219 is YES, the continuous shooting process is completed (step S221).

In the following, a description will be given of states of the image pickup apparatus and the storage areas Crw1 and Crw2 of the memory 30 in the case of normal continuous shooting (first shooting) and states of the image pickup apparatus and the storage areas Crw1 and Crw2 in the case of continuous shooting (second shooting) performed in a shooting condition where noise reduction processing is required.

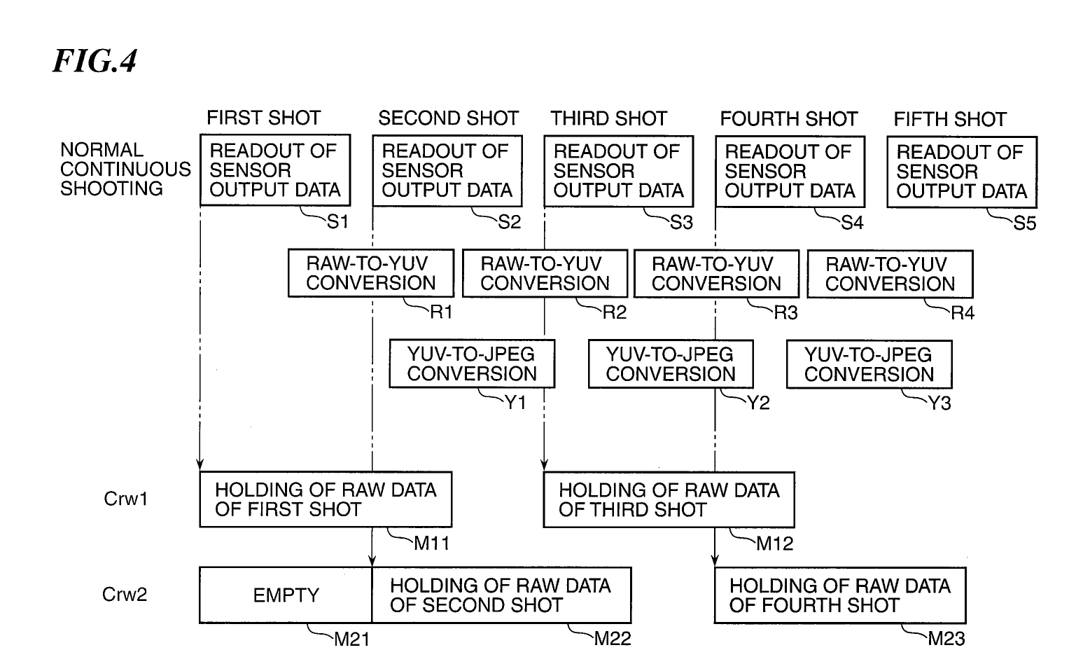

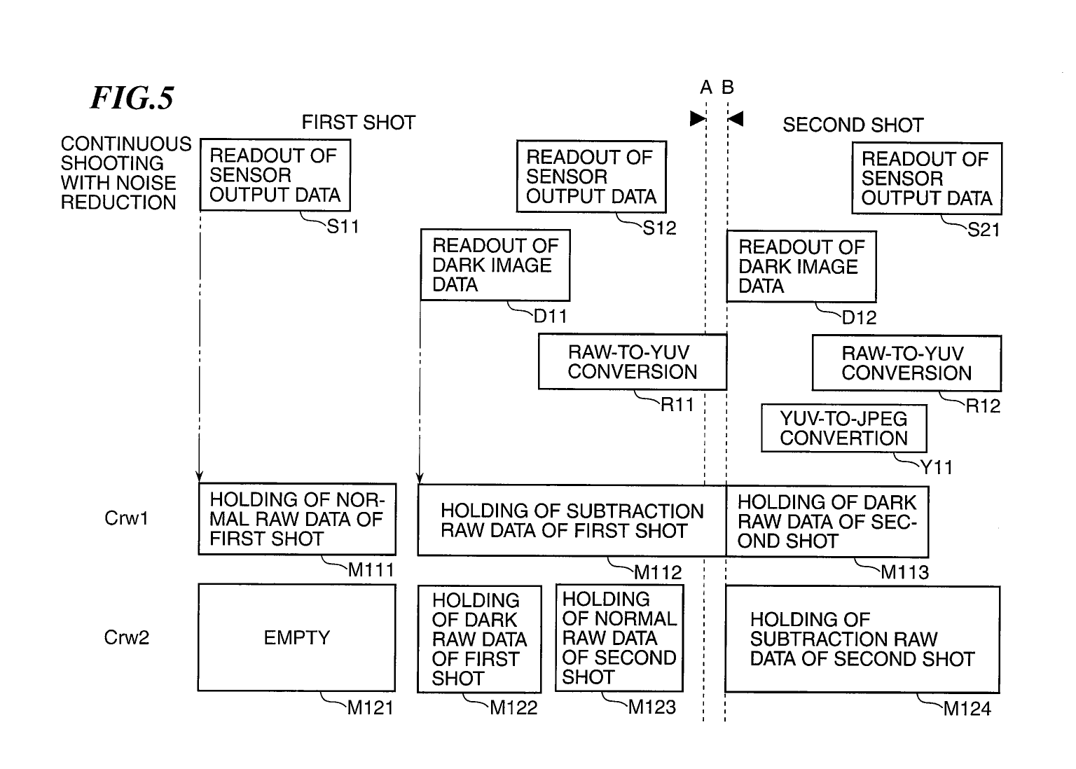

FIG. 4 shows states of the image pickup apparatus and the memory in time series in the case of normal continuous shooting, and FIG. 5 shows states of the image pickup apparatus and the memory in time series in the case of continuous shooting with noise reduction.

Referring to FIG. 4, in the case of normal continuous shooting, sensor output data (raw data) at a first shot in the continuous shooting is read from the image pickup device 14 (shown at S1). Upon completion of reading the sensor output data, YUV data is created from the raw data (shown at R1). Until the YUV data has been created, the sensor output data at the first shot is required to be retained in the storage area Crw1 of the memory 30.

Immediately after completion of reading the sensor output data of the first shot, the image pickup device 14 starts preparation for the second shot. Upon completion of the preparation, sensor output data of the second shot is read (shown at S2) and the read data is retained in the storage area Crw2 of the memory 30 (shown at M22). At that time, the sensor output data of the first shot is still required to be retained in the storage area Crw1 of the memory 30 (shown at M11).

In the case of an image pickup apparatus having a memory in which a storage area for retaining sensor output data (raw data) of only one still image is ensured, the second shot cannot be started before completion of conversion of the raw data of the first shot into YUV data. In the image pickup apparatus 100 of this embodiment, the storage area for retaining sensor output data (raw data) of two still images are ensured in the memory 30, as described above. As a result, the second shot can be started before completion of conversion of the raw data into the YUV data, whereby the continuous shooting speed can be increased.

In FIG. 4, symbols S3 to S5 denote readings of sensor output data of the third to fifth shots, symbols R2 to R4 denote conversions of raw data of the second to fourth shots into YUV data, and symbols Y1 to Y3 denote conversions of YUV data of the first to third shots into JPEG data. Symbol M12 denotes a state where the raw data of the third shot is retained in the storage area Crw1, symbol M21 denotes an empty state of the storage area Crw2, and symbol M23 denotes a state where the raw data of the fourth shot is retained in the storage area Crw2.

Referring to FIG. 5, in the case of continuous shooting performed in a shooting condition where noise reduction processing is required, sensor output data is read from the image pickup device 14 at the first shot in the continuous shooting (S11), and the resultant normal image data (normal raw data) is stored into the storage area Crw1 (M111). Immediately after completion of reading the sensor output data of the first shot (S11), dark shooting is performed, while closing the shutter 12, in the same condition as that in the continuous shooting at the first shot (D11), thereby obtaining a light-shielded image. The light-shielded image (dark raw data) is stored into the storage area Crw2 (M122), and noise-reduction processed image data is stored into the storage area Crw1 (M112).

The noise reduction processing on the normal raw data of the first shot is completed nearly simultaneously with completion of reading the light-shielded image data, and based on the resultant raw data after subtraction, YUV data is created (R11). Until the completion of creation of the YUV data, the sensor output data (raw data) of the first shot after subtraction is required to be retained in the storage area Crw1 (M112).

Immediately after completion of reading the sensor output data of the first shot (D11), the image pickup device 14 starts preparation for the second shot. Upon completion of the preparation, sensor output data of the second shot is read (S12), and the read sensor output data is retained in the storage area Crw2 of the memory 30 (M123).

Next, a light-shielded image is photographed. At that stage, if the conversion of noise-reduction processed image data of the first shot stored in the storage area Crw1 of the memory 30 into YUV data (R11) is not completed, shooting of a light-shielded image of the second shot must be on standby (during a time period from A to B shown in FIG. 5). The shooting of a light-shielded image of the second shot is allowed (D12) after completion of the conversion of the noise-reduction processed image data into YUV data (R11).

Due to the waiting for the period from A to B, the continuous shooting speed in the continuous shooting that requires the noise reduction processing becomes slightly lower. However, the resultant delay is insignificant since, in the continuous shooting that requires the noise reduction processing, a light-shielded image is originally required to be photographed and the shooting speed is originally lower than that in the normal continuous shooting. In other words, even at the time of the continuous shooting that requires noise reduction processing, defective pixels (defects) of the image pickup device can be detected from the light-shielded image, without using a memory dedicated to store the light-shielded image.

In FIG. 5, symbol M121 denotes an empty state of the storage area Crw2, symbol M124 denotes a state where subtraction raw data of the second shot is retained in the storage area Crw2, and symbol M113 denotes a state where dark raw data of the second shot is retained in the storage area Crw1. Symbol Y11 denotes the conversion of YUV data of the first shot into JPEG data, symbol R12 denotes the conversion of subtraction raw data of the second shot into YUV data, and symbol S21 denotes the reading of sensor output data of the third shot.

According to this embodiment, the following functions and effects can be achieved as previously described. At the time of continuous shooting, control is made such that both the storage areas Crw1 and Crw2 of the memory 30 are used to store normal image data. At the time of shooting that requires noise reduction processing to subtract light-shielded image data from normal image data, control is made such that the storage area Crw1 (or Crw2) is used to store normal image data and the storage area Crw2 (or Crw1) is used to store light-shielded image data. In other words, one of the two storage areas of the memory 30 is made available for storage of light-shielded image data at the time of shooting that requires the noise reduction processing.

Accordingly, the continuous shooting speed at the time of normal continuous shooting can be made faster by ensuring that the memory 30 has the storage areas for normal image data of two still images, while making one of the storage areas available for storage of light-shielded image data at the time of shooting that requires the noise reduction processing. It is therefore possible to provide a low-priced image pickup apparatus that does not require a memory dedicated to store light-shielded image data for the detection of defective pixels (defects) of the image pickup device.

### OTHER EMBODIMENTS

In the above-described embodiment, the case has been described in which it is determined whether shooting requires noise reduction processing, and only at the time of shooting that requires the noise reduction processing, a light-shielded image is photographed and subtracted from a normal image and detected defects in the image after the subtraction are corrected. However, this invention is not limited thereto. For example, this invention can be implemented in a form where the light-shielded image is always photographed or in a form where the light-shielded image is photographed according to the operation mode of the image pickup apparatus (such as, for example, that the light-shielded image is always photographed in a nightscape mode). Corrections to the detected defects can also be performed for the normal image other than the noise-reduction processed image.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-103191, filed Apr. 28, 2010, which is hereby incorporated by reference herein in its entirety.

What is claimed is:

1. An image pickup apparatus comprising:
an image pickup device configured to photoelectrically convert an optical image into an image signal and output the image signal;
an A/D conversion unit configured to convert the image signal output from said image pickup device into digital image data;
a storage unit having at least first and second storage areas and configured to store the digital image data; and
a control unit configured to perform control to store first image data photographed in a state where said image pickup device is not light-shielded into both the first and second storage areas when first shooting is performed, said control unit being configured to perform control to store the first image data into one of the first and second storage areas and store second image data photographed in a state where said image pickup device is light-shielded into another of the first and second storage areas when second shooting is performed.

2. The image pickup apparatus according to claim 1, wherein the first shooting is continuous shooting in which plural images are continuously photographed, and the second shooting is shooting in which noise reduction processing to subtract the second image data from the first image data is performed.

3. The image pickup apparatus according to claim 1, including:
an acquisition unit configured to perform the noise reduction processing by subtracting the second image data from the first image data to thereby acquire third image data,
wherein said control unit stores the third image data into the one of the first and second storage areas of said storage unit.

4. The image pickup apparatus according to claim 2, including:
a detection unit configured to detect, as defects, pixels in the second image data each having a pixel level equal to or greater than a predetermined threshold value;
a storing unit configured to store address data of the pixels detected as the defects by said detection unit; and
a correction unit configured to correct portions of the noise-reduction processed image data that correspond to the pixels detected as the defects by said detection unit and having the address data stored in said storing unit.

5. The image pickup apparatus according to claim 4, including:
a counting unit configured to count a number of the pixels detected as the defects by said detection unit,
wherein in a case where a storage amount of address data corresponding to the number of pixels counted by said counting unit exceeds a capacity of said storing unit, said detection unit changes the threshold value and again performs the detection.

6. A control method for an image pickup apparatus including an image pickup device configured to photoelectrically convert an optical image into an image signal and output the image signal, an A/D conversion unit configured to convert the image signal output from the image pickup device into digital image data, and a storage unit having at least first and second storage areas and configured to store the digital image data, comprising the steps of:
performing control to store first image data photographed in a state where the image pickup device is not light-shielded into both the first and second storage areas when first shooting is performed; and
performing control to store the first image data into one of the first and second storage areas and store second image data photographed in a state where the image pickup device is light-shielded into another of the first and second storage areas when second shooting is performed.
